(19) United States
(12) Patent Application Publication
(10) Pub. No.: US 2002/0051566 A1
(43) Pub. Date: May 2, 2002

(54) Defect inspection apparatus and method

(75) Inventor: Kyoji Yamashita, Kanagawa-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kabushiki Kaisha Toshiba, Minato-ku (JP)

(21) Appl. No.: 09/960,355

(22) Filed: Sep. 24, 2001

(30) Foreign Application Priority Data
Sep. 28, 2000 (JP) P2000-297430

(51) Int. Cl. G06K 9/00

(52) U.S. Cl. 382/151

(57) ABSTRACT

A defect inspection apparatus capable of precluding, or at least minimizing, the risk of erroneous recognition while simulating an accurate optical image from design data, and using it as reference data in masks using based resolution enhancement techniques such as phase-shift masks, or else by performing defect inspection by optically reading a pattern on a test substrate having the pattern, converting it into scanned image data for use as electrical image information, and then comparing the scanned image data with reference data indicative of an optical image obtainable from design data of the test substrate by simulation.

### CROSS-REFERENCE TO A RELATED APPLICATION

This application is based upon and claims the benefit of priority from the prior Japanese Patent Application No. P2000-297430, filed on Sep. 28, 2000, the entire contents of which are incorporated herein by reference.

### BACKGROUND OF THE INVENTION

1. Field of the Invention

The present invention relates in general to a defect inspection apparatus and method for detecting defects in a substrate having more than one pattern. Examples of substrates having such patterns include, but are not limited to, photo-masks or reticles, liquid crystal displays (LCD) panels, and printed circuit boards (PCB).

2. Discussion of the Background

Large-scale integrated circuit (LSI) patterns for semiconductor devices are transferred onto wafers from photo-masks. The photo-masks are fabricated so that mask writers such as an electron beam exposure apparatus or a laser-beam writer apparatus can write a plurality of desired patterns. If defects such as pin-dots or pinholes are located on the photo-masks, then they can have a significant influence on the resultant circuit patterns that are transferred onto the wafers. This would cause critical problems, including, but not limited to, drastic reductions in performance and yield.

To avoid these problems, it is essential to perform defect inspection and repairing, if necessary, after the photo-masks have been written by mask writers. To this end, the employment of a cutting-edge defect inspection apparatus is required, which detects such detrimental defects in the photo-mask patterns with 100 percent accuracy. For the generation of 130 nm nodes by photolithography, defects as small as 100 nm need to be detected. Additionally, in recent years, in order to further minimize the critical feature size of circuit patterns on wafers, advanced photo-masks employing resolution enhancement techniques have been adopted, such as phase-shift masks and optical proximity effect correction (OPC) masks.

Typical examples of phase-shift masks for resolution enhancement are the attenuated phase-shift mask that uses as its “absorber” a halftone membrane such as molybdenum silicide (MoSi) or the like instead of chromium membrane, as in a conventional binary mask, and the alternating phase-shift mask, the so-called Levenson mask, which is fabricated with quartz glass engraved on a binary mask. Either one of these masks is such that both optical amplitude and phase are controlled precisely, which is a technique for improving photolithography margins, including the exposure dose and focal depth.

On the other hand, the OPC masks are for suitably setting critical dimension at a desired value while at the same time precluding non-uniformity of such critical dimensions, which otherwise can vary in accordance with the pattern density of the circuit pattern to be transferred. This is the technique used for correcting a critical dimension that is variable in value due to exposure by adding an auxiliary pattern to, or subtracting an auxiliary pattern from, the original on-the-mask pattern size, to thereby correct non-uniformity of the resultant pattern sizes.

A prior known approach to inspecting phase-shift masks and optical-proximity-effect correction masks is to employ the following methodology. Firstly, uniformly illuminate a photo-mask with light while simultaneously scanning the pattern by use of an X-Y stage. A charge-coupled device (CCD) or the like is used to photo-electrically scan such light-irradiated patterns. With this photo-mask image being used as scanned data, apply image processing thereto. Having prepared in advance, or generating simultaneously, reference data for use as a standard image, compare the reference data and the scanned data to identify the differing portions as defects.

Currently available reference data generation methods typically include a die-to-die comparison scheme and a die-to-database comparison scheme. The die-to-die comparison scheme is such that the above-noted method is employed to scan the optical image of a photo-mask with the same pattern being formed thereon for test use, which is then subjected to image processing. Resultant image-processed data is adaptable for use as the reference data required. The die-to-database comparison scheme is such that the expansion data expanded from the design data of a circuit pattern is used as the reference data.

The die-to-die comparison scheme assumes that the test-use photo-mask is virtually free from any defects in the same portion of the dies that are compared to each other; unfortunately, this assumption is not justified: a few of defects can still be present. In cases where defects happen to exist commonly in a region to be compared to a photo-mask of the reference, such defects can possibly be overlooked.

Alternatively the die-to-database scheme offers the capability to obtain ideal reference data due to the fact that the design data per se is subject to simulation for use as the reference data. However, there is a tradeoff between higher sensitivity and computation complexity concerning the fidelity of reference data to the scanned data. To improve the fidelity, simulation methodology of high-level precision must be used to obtain the intended reference data from the design data, which would result in an unwanted increase in the amount of calculation. Additionally, with prior art simulation methods, results fail to match real images in the case of phase-shift masks, due to the absence of any careful consideration about interferences due to possible optical phase differences. With the optical-proximity-effect correction masks, minimizing the size of an auxiliary pattern can rapidly increase to the extent that it becomes as small as one fourth of minimum feature size, a widely accepted trend in micro-fabrication using photolithography technologies. It has also become difficult to simulate such ultra-fine or “micro” patterns.

### SUMMARY OF THE INVENTION

It is therefore an object of the present invention to provide a new and improved defect inspection apparatus and a defect inspection method capable of creating reference data through simulation of an accurate optical image from design data without suffering from any risks of erroneous recognition.

In accordance with a first aspect of the invention, there is provided a defect inspection apparatus for inspecting defects by optically scanning a pattern on a test substrate having the pattern, converting it into scanned image data for use as electrical image information, and then comparing said scanned data with reference data indicative of an optical image obtainable from design data of said test substrate, including:

a first processor unit creating binary or multi-value expansion data by expanding said design data and obtaining one of complex transmission distribution data and complex reflection distribution data of said test substrate;

a second processor unit calculating said reference data by using one of said complex transmission distribution data and said complex reflection distribution data passed through multiple complex finite impulse response (FIR) filters; and

a comparator unit comparing said scanned image data with said reference data.

In accordance with a second aspect of the invention, there is provided a defect inspection method for inspecting defects by optically reading a pattern on a test substrate having the pattern, converting it into scanned image data for use as electrical image information, and then comparing said scanned image data with reference data indicative of an optical image obtainable from design data of said test substrate, including:

creating binary or multi-value expansion data by expanding said design data;

obtaining one of complex transmission distribution data and complex reflection distribution data of said test substrate;

calculating said reference data by using one of said complex transmission distribution data and said complex reflection distribution data passed through complex coefficient multiple FIR filters; and

comparing said scanned image data with said reference data.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a diagram schematically depicting the overall configuration of the defect inspection apparatus in accordance with one embodiment;

FIG. 2 is a block diagram to explain the data processing method implemented in the defect inspection apparatus in accordance with the embodiment;

FIG. 3 is a block diagram showing the reference data calculation method in the defect inspection apparatus in accordance with the embodiment; and

FIGS. 4A and 4C depict optical images of bright field, and FIGS. 413 and 4D are optical images of dark, wherein FIGS. 4A-4B are optical images due to reference data obtained by filter calculation in accordance with the embodiment, whereas FIGS. 4C-4D are optical images as calculated by applying a strict partial coherent model to the same pattern.

### DETAILED DESCRIPTION OF THE PREFERRED EMBODIMENTS

One embodiment will now be set forth in detail with reference to the accompanying drawings below.

Referring to FIG. 1, FIG. 1 schematically shows an overall configuration of the defect inspection apparatus in accordance with the embodiment.

A test substrate (also called a sample or specimen in some cases) 30, having a pattern, is stably situated by vacuum adsorption on an X-Y stage 31 of the defect inspection apparatus, shown herein. Typical examples of the test substrate 30 are substrates with a multi-layer pattern such as a photo-mask, a reticle, a liquid crystal display (LCD) panel or equivalents thereto. Assume here that the test substrate is a photo-mask.

Light emitted from a light source 32, such as a high-pressure mercury lamp or the like, is reflected by a reflex mirror 34 to fall onto the test substrate 30. A condenser lens 33 uniformly illuminates the light irradiated from the light source 32 onto the test substrate 30. An objective lens 35 causes light that has passed through the pattern on test substrate 30 to be focused onto the image sensitive surface of a charge-coupled device (CCD) sensor 36.

At this time, the optical resolution is greatly improved, with a decrease in wavelength of the light source 32 and also with an increase in numeral aperture (NA) of the objective lens 35.

An optical image of the test substrate 30 is focused on the image sensitive surface of the CCD sensor 36. This optical image is converted by CCD sensor 36 into corresponding electrical image data. This image data is then digitized by an analog-to-digital (AD) data converter 37 into a digital scanned image data, which will be input to a comparator device to be compared with reference data, to be next explained below.

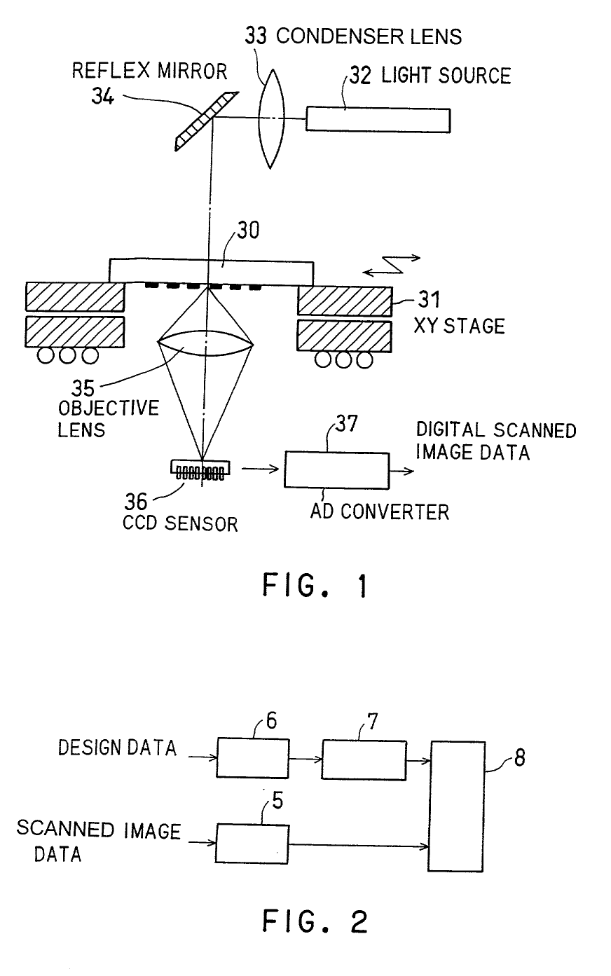

FIG. 2 is a block diagram that explains the data processing method used during defect inspection.

The scanned image data, as output from the AD converter 37 of FIG. 1, is input to a scanned image data to the input unit 5, shown in FIG. 2, for temporal storage therein. At this time, design data is simultaneously input to the unit 6 to obtain complex amplitude transmission distribution data (or alternatively complex amplitude reflection distribution data). At this stage, design data of each layer of the multi-layer pattern is used to create binary or multi-level value data to calculate complex amplitude transmission distribution data (or complex amplitude reflection distribution data) of the test substrate 30.

The processor unit obtains the complex transmission distribution data (or complex amplitude reflection distribution data) operates to generate a set of binary or multi-valued data through expanding each design data of the multi-layer patterns and then provide the complex transmission distribution data (alternatively reflection distribution data) that is obtained through multiplication of this expanded data by a complex amplitude transmission (or complex amplitude reflection) and summing the two multiplication results.

The complex amplitude transmission distribution data (or complex amplitude reflection distribution data) thus calculated through this processing is input to a reference data calculation unit 7, which is for calculating the reference data to be compared. Preferably this reference data calculation unit is arranged to perform processing by letting the complex transmission distribution data (or complex reflection distribution data) pass through multiple complex FIR filters.

This reference data, output from the reference data calculation unit 7, and the scanned image data output from the scanned image data input unit 1, are compared to each other at the comparator unit 8 to detect any possible defects.

An explanation will next be given of processing of unit 6, to obtain the complex amplitude transmission distribution data, and unit 7, to calculate the reference data. As in the case of the complex amplitude reflection distribution data, similar results are obtainable by setting a physical property value at the complex amplitude reflection coefficient in the following explanation; thus, a repetitive explanation thereof will be eliminated herein.

Firstly, expand from the design data the ratio of clear area to one pixel; then, obtain expanded data. This expanded data is such that the ratio of clear area to one pixel is obtained in binary value or multi-level value. Employing multilevel value makes it possible to more precisely represent the expanded data required.

At this time, in the case of a chromium mask or single-layered phase-shift mask, expand design data of a single layer. Letting the transmission of the glass substrate of a single-layer mask be 1, the intensity transmission of an absorbing member or “absorber” be t², and the phase difference be φ, the absorber's resulting complex amplitude transmission factor or “transmission” becomes equal to t·exp(iφ) with i=✓−1. At this time, letting the expanded data of such a mask (ratio of clear area to a pixel) be 0≦E(m,n)≦1, the complex amplitude transmission distribution F(m,n) is given as:

F(m,n)=E(m,n)+t·exp(iφ)(1−E(m,n))

Alternatively, for a multi-layer mask such as the ternary or tri-tone mask and the Levenson mask, expand from the design data of each layer the ratio of clear area to one pixel; then obtain expanded data. This expanded data is generated such that the ratio of clear area to one pixel is obtained in binary or multi-level value. Using the multi-level value enables more precise representation of the expanded data involved.

In the case of a ternary or tri-tone mask, letting the transmission of glass substrate be set at 1, the intensity transmission of an absorber be t², and a phase difference be φ with i=✓−1, the absorber's complex amplitude transmission is equal to t·exp(iφ). At this time, letting the mask's expanded data be 0≦E(m,n)≦1 while letting expanded data of a half-tone pattern be 0≦E′(m,n)≦1, the complex amplitude transmission distribution F(m,n) is represented by:

F(m,n)=E(m,n)+t·exp(iφ)·E′(m,n)

In the case of the Levenson mask, letting the transmission of the glass substrate be set at 1.0, the intensity transmission of an absorber be 1.0, and the phase difference of the shifter be φ with i=✓−1, the absorber's complex amplitude transmission becomes t·exp(iφ). At this time, letting the mask's expanded data be 0≦E(m,n)≦1 while letting the shifter pattern's expanded data be 0≦E′(m,n)≦1, the resultant complex amplitude transmission distribution F(m,n) is represented as:

F(m,n)=E(m,n)+exp(iφ)·E′(m,n)

From the foregoing, it can be appreciated that the complex amplitude transmission distribution data is obtained through generalization with respect to the above-stated three different types of masks by employing the following equation:

F(m,n)=E(m,n)+t·exp(iφ)·E′(m,n)

Next, let the complex amplitude transmission distribution data thus obtained in the way stated supra be input to the reference data calculator unit 7.

Processing for calculation of this reference data will be explained below.

The image intensity distribution upon irradiation of light, I(xₗ,yᵢ), is represented by the following Equation (1). Here, the term B₀(x,y) is the phase coherency coefficient, K(x,y) is an image of point-source light, and F(x,y) is the complex amplitude transmission distribution of an object of interest. The phase coherency coefficient B₀(x,y) is represented by Equation (2), whereas the image of point source light K(x,y) is by Equation (3). Additionally, R* is a conjugate complex number.

I(xₗ,yᵢ)=∫∫B₀(x₀−x′₀,y₀−y′₀)F(x₀,y₀)F*(x′₀,y′₀) K(xᵢ−x₀,yᵢ−y₀)K(xₗ−x′₀,yᵢ−y′₀)dx₀dy₀dx′_{0dy′}₀ (1)

B₀(x,y)=2J₁(u)/u,u≡2πσ\sqrt{x²+y²} (2)

φ is the ratio, NA_{c}/NA₀ of the numeral aperture NA_{c} of condenser lens to the numeral aperture NA₀ of objective lens, X is the wavelength of light source, and J₁(x) is the first Bessel function of the first kind. Note here that Cartesian coordinates are normalized so that x¹=NA₀ₓ/λ,y¹=NA_{0y}/λ.

$$K ( x , y ) = exp ( - i2 π \frac{{z}^{′}}{{NA}_{o}^{2}} ) \int \int exp [ i2 π \{ ξ {x}^{′} + η {y}^{′} + 0.5 {z}^{′} \cdot ( {ξ}^{2} + {η}^{2} ) + W ( ξ , η ) \} ⅆ ξ ⅆ η \qquad ( 3 )$$

where, NA₀ is the numerical aperture of an objective lens, λ is the wavelength of light source, wherein normalization is done so that x′=NA₀ₓ/λ,y′=NA_{0y}/λ and z′=NA₀ₓ/λ, respectively. z denotes the degree of defocus, and W(ξ,η) denotes the wave front aberration of the objective lens.

Next, digitizing the Equation (1) on a pixel-wise basis, we obtain Equation (4) as:

I(m,n)=ΣΣΣΣB₀(m₀−m′₀,n₀−n′₀)F(m₀,n₀)F*(m′₀,n′₀) K(m−m₀,−n₀)K*(m−m′₀,n−n′₀) (4)

Note here that although any one of K(m,n) and B₀(m,n) has a maximum value at the origin, each of them rapidly becomes diminished with an increase in distance from the origin. Accordingly, the image intensity distribution I(m,n) may be approximated by Equation (5) given below:

I(m,n)=B₀(0,0)·{|K(m,n)|²+|F(m,n)|²}+2·Re[F*(m,n)·K*(0,0)·{(B₀(m,n)·K(m,n))⁰*F(m,n))}] (5)

The first term indicates the case of (m₀−m′₀,n₀−n′₀)=(0,0) whereas the second term shows the case of establishmnent of (m₀−m′₀,n₀−n′₀)≠(0,0) and (m−m₀,n−n₀)=(0,0) or, alternatively, (m₀−m′₀,n₀−n′₀)≠(0,0) and (m−m′₀,n−n′₀)=(0,0). Here, “*” is used to denote a convolution integral. To be brief, we obtain f(m,n)*g(m,n)=ΣΣf(m−m₀, n−n₀)·g(m₀,n₀).

In addition, Equation (4) is formulated into Equation (6) so that the image intensity distribution I(m,n) is represented by complex coefficients. At this time, P(m,n) is a finite impulse response (FIR) filter comprised of real coefficients whereas Q(m,n) is a FIR filter formed of complex coefficients.

I(m,n)=P(m,n)*|F(m,n)|²+Re[F*(m,n){Q(m,n)*F(m,n)}] (6)

where Re[X] represents the real part of a complex number X, and in the case where

P(m,n)=B₀(0,0)|·IK(m,n)|²,

Q(m,n)=0 in case of (m,n)=(0,0),

and

Q(m,n)=2K*(0,0)·B0(m,n)·K(m,n) otherwise.

Additionally, when setting the complex coefficient FIR filter Q(m,n)=Qᵣ(m,n)+iQᵢ(m,n), F(m,n)=Fᵣ(m,n)+iFᵢ(m,n), we obtain from Equation (6) the following Equation (7):

I(m,n)=P(m,n)*{Fᵣ(m,n)²+Fᵢ(m,n)2}+Fᵣ(m,n){Qᵣ(m,n):*Fᵣ(m,n)−Qᵢ(m,n)*Fᵢ(m,n)}+Fᵢ(m,n){Qᵣ(m,n)*Fₗ(m,n)+Qᵢ(m,n)*Fᵣ(m,n)} (7)

As apparent from Equation (7), by setting the complex coefficient of the FIR filter Q(m,n) in the way noted above, the image intensity distribution I(m,n) is indicated by addition of five real parts as will be shown below.

I(m,n)=P(m,n)*{Fᵣ(m,n)²+Qᵣ(m,n)²}+Fᵣ(m,n)Qᵣ(m,n)*Fᵣ(m,n)−Fᵣ(m,n)Qᵢ(m,n)*Fₗ(m,n)+Fᵢ(m,n)Qᵣ(m,n)*Fᵢ(m,n)−Fᵢ(m,n)Qᵢ(m,n)*Fᵣ(m,n) (8)

Thus it is possible by using the FIR filter to obtain from the design data the reference data that correspond to the scanned image data.

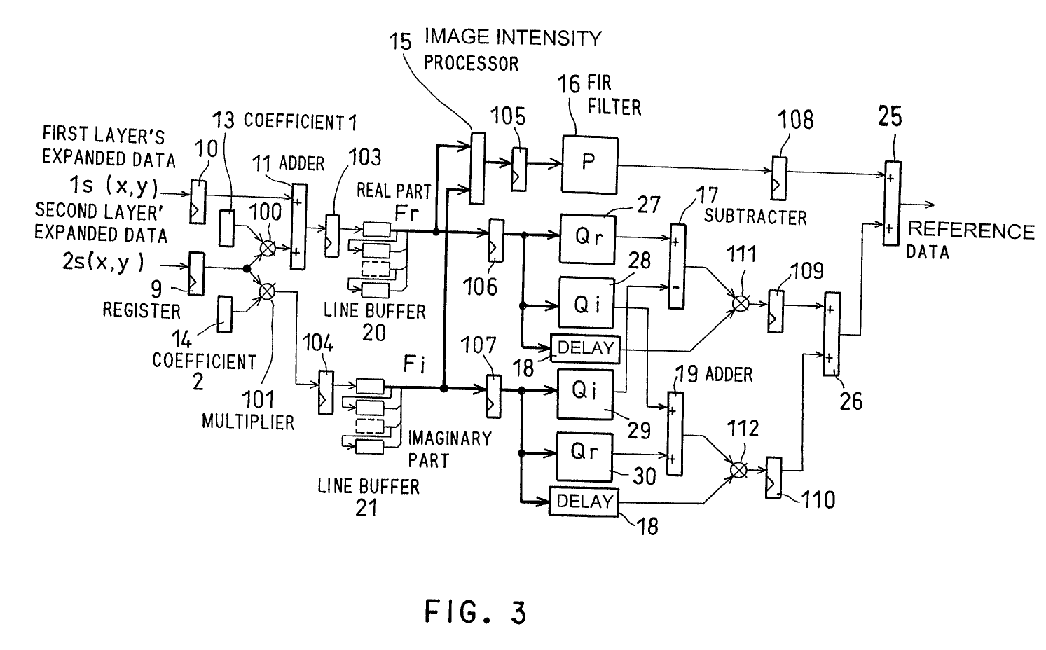

An explanation will next be given of one practical implementation of the processing method for obtaining the complex coefficient FIR filter by the five real FIR calculation method discussed above to thereby calculate reference data (image intensity distribution I(m,n)), with reference to FIG. 3.

The example shown herein is an example that calculates the reference data from design data of a specific mask structure with a mixture of a chromium mask and a phase-shift mask, known as a ternary or tri-tone mask among those skilled in the art. A first layer indicates clear patterns; a second layer shows phase-shift mask patterns. Note here that any overlap occurring between the first and second layer patterns on the design data should be required to be excluded. Overlap is removed from test data by data processing prior to the inspection procedure. Alternatively, such overlap removal is also attainable by excluding an overlap on a real time basis through logical arithmetic processing from input data of the first and second layers, prior to obtaining the complex transmission distribution data and alternatively complex reflection distribution data.

Letting the complex amplitude transmission of the phase-shift mask be t·exp(iφ) as stated previously, an appropriate value that corresponds to t·cos(φ) is set as a coefficient 1 at a coefficient hold/storage unit 13. In addition, a value corresponding to t·sin(φ) is preset as coefficient 2 at a coefficient hold/storage unit 14.

As shown in FIG. 3, the first layer's expanded data is input to and stored in a register 10. The second layer's expanded data is input for storage to a register 9. Next, the second layer's expanded data is input to a multiplier 100 for multiplication with the coefficient 1 as output from the coefficient storage unit 13 and then input to an adder 11. Substantially simultaneously, the first expanded data is also input to the adder 11 to add to the multiplication result of the second expanded data and coefficient 1. In this way the real part Fᵣ is thus obtained, which will then be input to a register 103.

On the other hand, the second layer's expanded data as output to a multiplier 101 is multiplied with the coefficient 2 as output from the coefficient storage unit 14 to thereby obtain imaginary part Fᵢ, which will be input to a register 104.

Next, the real part Fᵣ as an output from the register 103 is input to a line buffer 20 and then stored therein. The imaginary part Fᵢ being an output from the register 104 is input to a line buffer 21 and held therein. The real part Fᵣ being held in the line buffer 20 and the imaginary part Fᵢ as held in the line buffer 21 are input simultaneously to an image intensity processing unit 15 in conformity with the significance of the FIR filter used. This image intensity processor unit 15 uses the real part Fᵣ and imaginary part Fᵢ to obtain a value of Fᵣ²+Fᵢ², which is then output to a data hold/storage unit 105.

Additionally, the real part as output from the line buffer 20 is input to a register 106 and held therein, whereas the imaginary part Fₗ as output from the line buffer 21 is input to a register 107 for storage therein.

Next, the Fᵣ²+Fᵢ² data as output from the register 105 is input to the FIR filter 16 for convolution integration with the FIR filter P of the real number coefficient to thereby obtain the result of P*(Fᵣ²+Fₗ²) data (first term of Equation (7)), which is then output to register 108. Note that the symbol “*” represents the convolution integral operation.

Meanwhile, the real part Fᵣ, being held in the line buffer 20, is input to the register 106 and stored therein. The imaginary part Fᵢ, as held in the line buffer 21, is input for storage to the register 107.

The real part Fᵣ, being held in the register 106, is input to a complex FIR filter 27. This complex FIR filter 27 effectuates convolution integration of Qᵣ for calculation of Fᵣ*Qᵣ and then outputs it to a subtracter 17. The imaginary part Fᵢ, being held in the register 107, is input to a complex FIR filter 29. This complex FIR filter 29 performs convolution integration of Qₗ to calculate Fₗ*Qₗ and then outputs to the subtracter 17. The subtraction result of the subtracter 17, i.e., Fᵣ*Qᵣ−Fᵢ*Qₗ data, is then output to a multiplier 111. The real part Fᵣ, as output via a delay circuit 18, will also be output to the multiplier 111. This multiplication result Fᵣ(Fᵣ*Qᵣ−Fᵢ*Qᵢ) data (second term of Equation (7)) is input to register 109 and then retained therein.

The real part Fᵣ, being held in the register 106, is input to a complex linear response filter 28. The complex FIR filter 28 convolution-integrates Qᵢ to calculate FᵣQᵢ and then outputs to an adder 19. The imaginary part Fᵢ, as held in the register 107, is input to a complex FIR filter 30. This complex FIR filter 30 applies convolution integration to Qᵣ for calculation of FᵢQᵣ and then outputs to the adder 19. The addition result of adder 19, i.e., Fᵣ*Qᵢ+Fᵢ*Qᵣ, is output to multiplier 112. The imaginary part Fᵢ, as output via the delay circuit 18, is also output to the multiplier 112. Its multiplication result Fₗ(Fᵣ*Qᵢ+Fᵢ*Qᵣ) data (third term of Equation (7)) is input to a register 110 and then stored therein.

In the way stated above, the result of the processing executed by the complex FIR filters 27-30 is such that the real part is given by Qᵣ*Fᵣ−Qᵢ*Fᵢ whereas the imaginary part is given as Fᵣ*Qᵢ+Fᵢ*Qᵣ. Real part output is achievable because of the fact that the real part Qᵣ*Fᵣ−Qₗ*Fᵢ is multiplied by real part Fᵣ while letting the imaginary part Fᵣ*Qₗ+Fᵢ*Qᵣ be multiplied by imaginary part Fᵢ.

Further, the data items (second and third terms of Equation (7)), being held in the registers 109, 110, are added together at an adder 26, causing its addition result to be added at an adder 25 to the data (first term of Equation (7)), as held in the register 108, to thereby obtain a final addition result for use as an image intensity distribution (right part of Equation (7)), which is then output as the reference data required.

The reference data thus obtained is input to the comparator unit 8 shown in FIG. 2 and will then be subject to comparison with scanned image data.

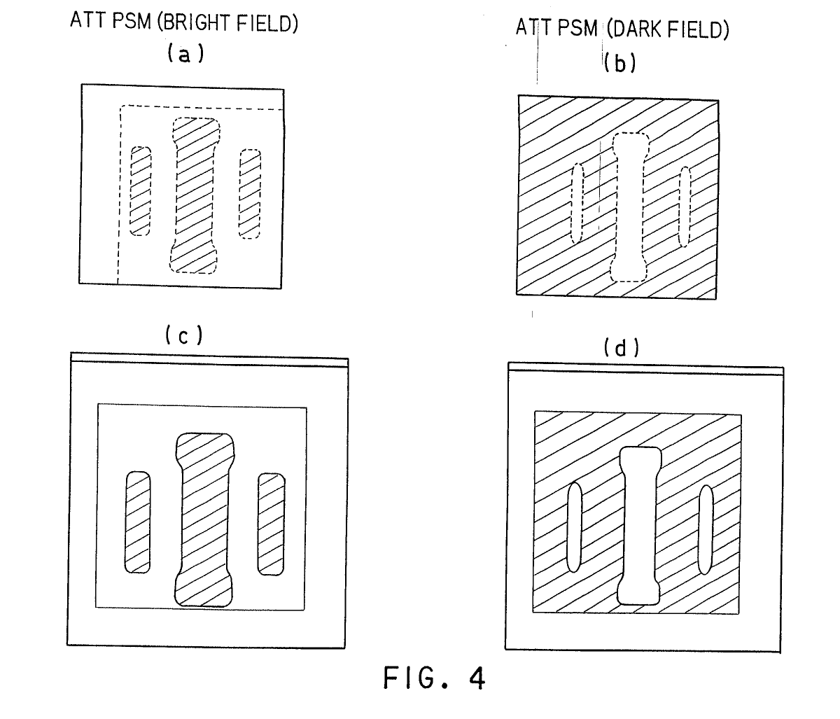

Turning to FIGS. 4A to 4D, there are shown some major image patterns each indicating the image intensity of the reference data as obtained in the method stated supra. FIGS. 4A and 4C show optical images of the bright field whereas FIGS. 4B and 4D show optical images of dark field. Additionally FIGS. 4A-4B each depict the reference data as obtained through filter calculation in accordance with this embodiment. FIGS. 4C-4D are simulation results, each of which was calculated while applying a rigorous partial coherent model to an identical pattern.

It is readily apparent, by comparison of the bright field cases of FIGS. 4A and 4C, that the pattern of FIG. 4A, obtained through calculation in consideration of the phase of light using the FIR filter of complex coefficients, is identical with maximal fidelity to the pattern of FIG. 4C, which was calculated using the rigorous partial coherent model. These figures demonstrate that the use of such a scheme for obtaining optical image(s) by calculation in view of light phase, using more than one complex coefficient FIR filters that are efficient in this calculation method, may result in successful representation of the difference in image profile between bright and dark fields, and also the difference in image profile between the chromium mask and phase-shift mask, which differences have been difficult to represent in the prior art.

Similarly, with the dark field cases of FIGS. 4B and 4D also, it is apparent that the pattern of FIG. 4B, as calculated in view of light phase using the FIR filter of complex coefficients, is nearly identical to that of FIG. 4D as calculated by the strict partial coherent model.

In this way, in accordance with the present invention, it becomes possible to obtain by simulation the required reference data, which is nearly identical to the optical image of a test substrate as has been sensed or picked up upon actual irradiation of light thereto, which in turn makes it possible to preclude creation of any unwanted recognition errors of the inspection apparatus used, thus enabling further improvement in accuracy of die-to-database schemes.

It has been stated that, according to the present invention, high-accuracy optical images may be successfully simulated from design data, even in those masks employing resolution enhancement techniques; thus it is possible to provide an apparatus which prevents nuisance defects from being detected, even when using it as reference data for comparison. It is also possible to calculate the reference data with maximal accuracy in accordance with optical illumination conditions (light source wavelength of inspection apparatus, numerical aperture (NA) of an objective lens, partial coherence factor, degree of defocus or the like), lens aberration (spherical, astigmatism, coma aberrations or otherwise), mask absorber's physical properties (transmission amplitude, reflection amplitude, phase differences at the inspection wavelength), and others.

In the description above, the reference data was obtained with respect to all surfaces of the test substrate in an all-at-a-time fashion for comparison with the optical image of a specimen or sample. The present invention should not be limited only to this method, and may also be arranged so that a pixel immediately before the to-be-compared pixel is obtained through simulation as the reference data and then subjected to comparison with an optical image corresponding to such pixel.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed as new and is desired to be secured by Letters Patent of the United States is:

1. A defect inspection apparatus comprising:
a first processor unit configured to create at least one of a binary expansion data and a multivalued expansion data by expanding a design data and obtaining one of a complex transmission distribution data and a complex reflection distribution data of a test substrate;
a second processor unit configured to calculate a reference data by using one of said complex transmission distribution data and said complex reflection distribution data passed through multiple complex coefficient finite impulse response filters; and
a comparator unit configured to compare a scanned image data with said reference data.

2. The apparatus of claim 1, wherein said pattern is a multi-layer pattern and said first processor unit is operable to create said expansion data by expanding said design data of each layer of said multi-layer pattern.

3. The apparatus of claim 1, wherein said first processor unit is operable to obtain one of said complex amplitude transmission distribution data and said complex amplitude reflection distribution data by executing multiplication and addition of said expansion data and one of a complex amplitude transmission coefficient and complex amplitude reflection coefficient respectively.

4. The apparatus of claim 1, wherein said second processor is configured to perform multiplication with a conjugate complex number of one of said complex transmission distribution data and said complex reflection distribution data after passing through said complex coefficient finite impulse response filter.

5. The apparatus of claim 2, wherein if a plurality of patterns overlap each other in the design data of said plurality of layers to form at least one overlapping part, said at least one overlapping part is removed.

6. The apparatus of claim 1, wherein said comparator unit is configured to compare said scanned image data with said reference data sequentially on a per-pixel basis.

7. The apparatus of claim 1, wherein said reference data is obtained with respect to all surfaces of said test substrate on an all-at-a-time basis.

8. The apparatus of claim 1, wherein said reference data is obtained with respect to a pixel immediately before a pixel to be compared.

9. The apparatus of claim 1, wherein said expansion data is such that a ratio of a pattern occupying more than one pixel at a transmission portion is obtained by at least one of a binary and a multivalued expansion data.

10. The apparatus of claim 1, wherein said first processor unit performs a logical operation.

11. A defect inspection method comprising the steps of:
creating at least one of a binary expansion data or multivalued expansion data by expanding a design data;
obtaining one of a complex transmission distribution data and a complex reflection distribution data of a test substrate;
calculating a reference data by using one of said complex transmission distribution data and said complex reflection distribution data passed through multiple complex finite impulse response filters; and
comparing a scanned image data with said reference data.

12. The method of claim 11, wherein said pattern is a multi-layer pattern and wherein said step of creating comprises expanding said design data of each layer of said multi-layer pattern.

13. The method of claim 11, wherein said step of obtaining comprises performing multiplication and addition of said expansion data and one of a complex amplitude transmission coefficient and complex amplitude respectively.

14. The method of claim 11, wherein said step of calculating comprises performing multiplication with a conjugate complex number of one of said complex transmission distribution data and said complex reflection distribution data after passing through said complex coefficient finite impulse response filter.

15. The method of claim 12, wherein if a plurality of patterns overlap each other in the design data of said plurality of layers to form at least one overlapping part, said at least one overlapping part is removed.

16. The method of claim 11, wherein said step of comparing comprises sequentially comparing on a per-pixel basis.

17. The method of claim 11, wherein said reference data is obtained with respect to all surface of said test substrate on an all-at-a-time basis.

18. The method of claim 11, wherein said reference data is obtained with respect to a pixel immediately before a pixel to be compared is obtained.

19. The method of claim 11, wherein said expansion data is such that a ratio of a pattern occupying more than one pixel at a transmission portion is obtained from a binary or multivalued data.

20. The method of claim 11, wherein said step of creat ing comprises performing a logical operation.

21. A computer readable medium containing program instructions for execution on a computer system, which when executed by the computer system, cause the computer system to perform the method recited in any one of claims 11-20.
